(19) United States
(12) Patent Application Publication
(10) Pub. No.: US 2003/0204547 A1
(43) Pub. Date: Oct. 30, 2003

(54) Technique for scheduling computer processes

(76) Inventors: Kevin Davis, Columbia, MD (US); Stephen Frederick Engdahl, Baltimore, MD (US)

Correspondence Address: ANTONELLI, TERRY, STOUT & KRAUS, LLP, Suite 1800, 1300 North Seventeenth Street, Arlington, VA, 22209, US

(21) Appl. No.: 10/133,648

(22) Filed: Apr. 29, 2002

(51) Int. Cl. G06F 9/00

(52) U.S. Cl. 709/101

(57) ABSTRACT

A technique for performing a batch process is provided. The technique includes storing information which identifies a process. The identified process is a process other than a scheduled process. When performance of the identified process is detected a batch process is performed.

### FIELD OF THE INVENTION

The present invention relates to computer processing and more particularly to execution of predefined computer processes.

### BACKGROUND OF THE INVENTION

A computerized batch process is a process which operates on data without user interaction. For batch processes, a user provides a computing device with a “batch” of data and instructs the computer to process the data. The actual processing of the data is asynchronous with respect to the user. That is, the user provides the data, instructs the computer to process the data, and thereinafter the user is not involved in the processing.

Beneficially, batch processes can be triggered without direct user interaction through the use of application management software known as schedulers. Schedulers include a user interface that supports a specification of the batch processes and definition of execution parameters. The execution parameters are the schedules, i.e., when a batch process, or processes, should be executed. Schedulers also include a control agent which controls the execution of the defined schedules, i.e., executes the execution parameters. That is, causes a batch process to be executed.

Sophisticated, and typically expensive, independent commercial schedulers are available, often as part of system or application management software suites. Often commercial schedulers are bundled with other software. Also, software solution providers have developed proprietary schedulers designed to function with specific application systems. These proprietary schedulers are typically rudimentary, as they only function with specific application systems.

Commercial and proprietary schedulers support various types of scheduling. The simplest of these is time-based scheduling. Batch processes are triggered at particular points in time. Interdependency between processes is not supported. FIG. 1 is a simplified depiction of time-based scheduling. As shown, at 20:00 hours the scheduler triggers Process A 102, at 24:00 hours the scheduler triggers Process B 104, and at 02:00 hours the scheduler triggers Process C 106.

Another type of scheduling is serial scheduling. Serial scheduling allows batch process interdependencies to be defined, providing for the use of resources to be optimized. The completion of one batch process triggers the beginning of another batch process. Serial scheduling requires close cooperation between the scheduler and the operating system so that the control agent can identify when batch processes start and stop. Thus, the operating system must communicate process statuses to the control agent.

FIG. 2 is a simplified depiction of serial scheduling. As shown, at 20:00 hours the scheduler triggers Process A 202. Completion of Process A 202 causes the scheduler to trigger the execution of Process B 204. Likewise, completion of Process B 204 causes the scheduler to trigger the execution of Process C 206.

Another type of scheduling is parallel scheduling. In parallel scheduling distinct schedules are triggered at the same point in time or at different points in time. Thus, in parallel scheduling, the scheduler executes multiple batched processes to run at the same time. However, the scheduler does not ensure that the batch processes can run at the same time without conflict.

FIG. 3 is a simplified depiction of parallel scheduling. As shown, the scheduler triggers execution of Process A 302 at 20:00 hours. Completion of Process A 302 causes the scheduler to trigger the execution of Process B 304. In turn, completion of Process B 304 causes the scheduler to trigger the execution of Process C 306. The scheduler also triggers the execution of Process D 308 at 22:00 hours. Completion of Process D 308 causes the scheduler to trigger the execution of Process E 310. And, completion of Process E 310 causes the scheduler to trigger the execution of Process F 312.

Another type of scheduling is divergent/convergent scheduling. For divergent scheduling, the completion of one batch process causes the scheduler to trigger multiple batch processes, effectively triggering parallel sub-schedules. For convergent scheduling, the completion of multiple batch processes causes the scheduler to trigger a single batch process.

FIG. 4 is a simplified depiction of divergent/convergent scheduling. As shown, the scheduler triggers execution of Process A 402 at 20:00 hours. Completion of Process A 402 causes the scheduler to trigger the execution of Process B 404, Process E 410, and Process G 414. Completion of Process B 404 causes Process C 406 to be executed, whose completion causes Process D 408 to be executed. Completion of Process E 410 causes Process F 412 to be executed. The scheduler does not trigger execution of Process H 416 until each of Process D 408, Process F 412, and Process G 414 are completed.

Another type of scheduling is concurrent scheduling. In concurrent scheduling, a scheduler supports the triggering of more than one instance of a given batch process at the same time. However, the scheduler is not responsible for ensuring that these multiple instances of the same batch process can execute successfully in parallel without conflict.

FIG. 5 is a simplified depiction of concurrent processing. As shown, at 20:00 the scheduler triggers the execution of Process A 502. Completion of Process A 502 causes the scheduler to trigger execution of Process B 504, Process B′ 504′, and Process B″ 504″ at the same time.

Yet another type of scheduling is alternate scheduling. In alternate scheduling, the occurrence of different events causes the scheduler to trigger the execution of different processes. Typically, the events are success of a process and failure of a batch process.

FIG. 6 is a simplified depiction of alternate path scheduling. As shown, at 20:00 hours the scheduler triggers the execution of Process A 602. If Process A 602 is successful, the scheduler triggers execution of Process B 604. If Process A fails, the scheduler triggers the execution of Process C 606.

Sophisticated schedulers can perform these scheduling types at the same time. For example, a concurrent schedule can be run at the same time as a parallel schedule.

Schedulers schedule the batch processing of data which is often stored in one or more databases. A database is a collection of information which is used for more than one purpose. The contents of a database change due to the addition of a database entry, the deletion of a database entry, and the processing of a database entry which transforms the value of the entry. Addition, deletion, and transformation of a database entry is often caused by an interactive online application process (both PC- and Web-based), execution of an ad hoc, i.e., unscheduled, batch process, or a database maintenance utility operation. Whenever the content of a database changes, it is often desirable to perform a given batch process on the newly formulated contents.

Distinct from schedulers, database managers exist which includes database triggers which cause predefined processes to take place if certain database elements (at the table and/or row level) are changed. However, database managers do not support the richness of sophisticated schedulers discussed above. Rather, a single process can be initiated if the contents of a database change. Further, database managers and schedulers do not communicate. Thus, actions taken by, and information generated by, a database manager cannot serve as triggering events for a scheduler, or otherwise be used by a scheduler. As a result, many users must utilize both database managers and schedulers to direct processes. A database manager is used to cause a batch process to be executed based upon changed contents of a database, while a scheduler is used to cause the batch process to be executed in some periodic fashion. Such users must look to two places to manage the same batch process, which at best is inefficient.

Today's application systems typically include a variety of processes operating on a variety of databases and other collections of data. These processes include traditional batch processes, ad hoc batch processes, and even message queue-based processes. Additionally, data stored in databases and other collections is modified from a variety of sources, including interactive online user interfaces, application system batch processes, as well as other processes. As a result, an application system's processes must be managed from a variety of schedulers and database managers.

Accordingly, a need exists for a technique to manage a variety of computerized processes utilizing a single process management application.

### OBJECTS OF THE INVENTION

It is an object of the present invention to provide a technique to manage a variety of computerized processes in a unified manner.

The above-stated object, as well as other objects, features, and advantages, of the present invention will become readily apparent from the following detailed description which is to be read in conjunction with the appended drawings.

### SUMMARY OF THE INVENTION

In accordance with a first embodiment of the present invention, a method and system for performing a batch process are provided. A batch process is a computing application which executes without requiring interaction with a human operator or client and typically processes a collection of data.

In accordance with this first embodiment, information which identifies a process other than a scheduled process is stored. A scheduled process is a process executed by a computing device which has defined starting criteria. The defined starting criteria could be a time, could be the execution of one or more other processes, or could be the completion of execution of one or more other processes. Thus, the identified process in accordance with this first embodiment is a process which does not have defined starting criteria.

Also in accordance with this first embodiment, performance of the identified process is automatically detected. Detection of the performance can be detection of a first performance of the process, or detection of any of multiple instances of performance of the identified process. Based upon detection of the performance of the identified process, a batch process is performed. Thus, a batch process is performed based upon the occurrence of a process other than a scheduled process.

According to one aspect of the first embodiment of the present invention, the identified process is performed on-line. That is, the process includes interaction from a human.

Yet another aspect of the first embodiment includes storing first detection information that indicates that performance of the identified process has been detected. Also, information representing a time is stored. A time corresponding to the stored timing information is detected and then second detection information that indicates that the time has been detected is stored. According to this aspect, the batch process is performed only if the first and the second detection information is stored. Thus, the batch process is performed only upon performance of the identified process and occurrence of the time.

In another aspect of the first embodiment, the identified process is one of a plurality of processes, each of the plurality of processes not scheduled processes. This aspect includes selecting the identified process from the plurality of processes prior to storing the first process identifying information.

In an especially beneficial aspect of this first embodiment of the present invention, the identified process is a first process selected from a first plurality of processes, each of the first plurality of processing being other than a scheduled process. First detection information indicating detection of the performance of the first process is stored. This aspect also includes selecting a second process from a second plurality of processes. This second plurality of processes could include both scheduled and unscheduled processes. Further, there could be overlap in processes included in the first and second pluralities. Information identifying the selected second process is stored. As with the first process, performance of the second process is detected. Second detection information indicating the detection of the performance of the second process is stored. The batch process is performed only if the first detection information and the second detection information are stored. That is, performance of both the first and second processes must be detected before the batch process is performed.

According to a further aspect of this first embodiment of the present invention, the first process is performed by a first computing application. The second process is performed by either the same computing application which performs the first process, or a second computing application.

In yet another aspect of the first embodiment, the identified process is an accounting process.

The system of the first embodiment comprises a memory and a processor. The memory can be any type of memory for storing data, and the processor can be any type processor capable of functioning as described herein. The memory is configured to store the instructions for performing the first process and the second process. The second process is the batch process. The memory is also configured to store information identifying the first process. The processor is configured to execute the first process and then detect performance of the first process based upon the stored information identifying the first process. The processor is also configured to execute the second process based upon detection of the performance of the first process.

According to other aspects of the first system embodiment, the memory is further configured to store the first and second detection information, and the timing information, as discussed above. Also according to this aspect, the processor is further configured to cause the first and second detection information to be stored in the memory, detect a time corresponding to the stored timing information. In this aspect, the second process is executed only if the first and second detection information are each stored in the memory. That is, the second process is not executed unless both the first process has been detected and the time has been detected.

According to another aspect of this first system embodiment, the memory is further configured to store the instructions for performing the third process and the information identifying the third process, as well as first detection information indicating the detection of the performance of the first process and second detection information indicating detection of performance of the second process.

The processor is further configured to cause the first and second detection information to be stored in memory, execute the third process, detect performance of the third process based upon the stored information identifying the third process, and execute the second process only if the first and second detection information are stored in the memory.

According to a second embodiment of the present invention, a method and system for executing a batch process are provided.

The method includes storing information identifying a first event. The first event is the performance of an unscheduled process. Also, the method includes storing information identifying at least one other event. Each of the at least one other events is either a performance of a scheduled process or a clocking of a time. Occurrence of the first event and the at least one other event is detected. Upon detection of the occurrence of the first event and the at least one other event, a batch process is executed. That is, a batch process is only executed upon occurrence of an unscheduled process as well as one or both of an occurrence of a time and occurrence of a scheduled process.

According to one aspect of the second embodiment of the present invention, the first event and the at least one other event are selected events. These events are selected from multiple events prior to storing the information identifying the first event and the information identifying the at least one other event.

According to yet another aspect of the second embodiment of the present invention, the unscheduled process is performed on-line. That is, human interaction is involved in performance of the unscheduled process.

According to still another aspect of the second embodiment of the present invention, at least the first event, and perhaps also the at least one other event, are associated with an computer application for accounting.

In another aspect of the second embodiment, performance of the unscheduled process alters a database. That is, the unscheduled process can add data to a database, remove data from a database, or modify existing data in a database, or any combination thereof.

The system of this second embodiment of the present invention includes a memory and processor, as discussed above. The memory is configured to store information identifying the first event and information identifying the at least one other event. The processor is configured to detect occurrence of the first event and the at least one other event. When the first event as well as the at least one other event have been detected, the processor executes a batch process. It should be noted that in this second embodiment, the processor does not necessarily have to perform the unscheduled process, though it certainly could. The processor could in fact detect another processor performing the unscheduled event.

It will also be understood by those skilled in the art that the invention is easily implemented using computer software. More particularly, software can be easily programmed, using routine programming skill, based upon the description of the invention set forth herein and stored on a storage medium which is readable by a computer processor to cause the processor to operate such that the computer performs in the manner described above.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a simplified depiction of time based scheduling according to the prior art.

FIG. 2 is a simplified depiction of serial scheduling according to the prior art.

FIG. 3 is a simplified depiction of parallel scheduling according to the prior art.

FIG. 4 is a simplified depiction of divergent/convergent scheduling according to the prior art.

FIG. 5 is a simplified depiction of concurrent scheduling according to the prior art.

FIG. 6 is a simplified depiction of alternate path scheduling according to the prior art.

FIG. 7 depicts an event manager dialog box in accordance with the present invention.

FIG. 8 depicts a dialog box for defining a new event-group in accordance with the present invention.

FIG. 9 depicts a dialog box for scheduling a data enrichment pass in accordance with the present invention.

FIG. 10 is a simplified depiction of the operations of a scheduler control agent in accordance with the present invention.

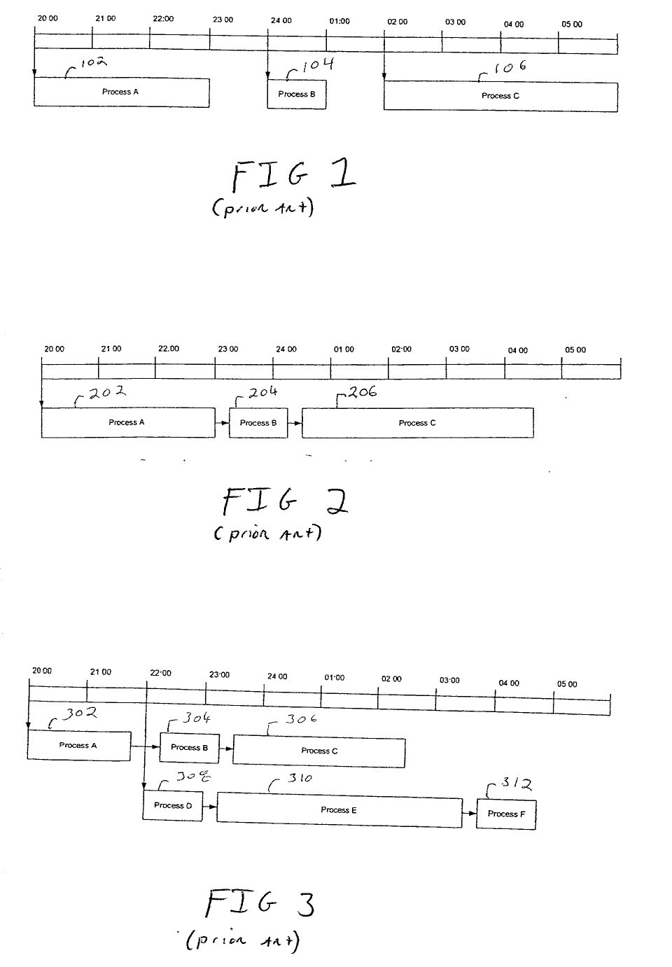

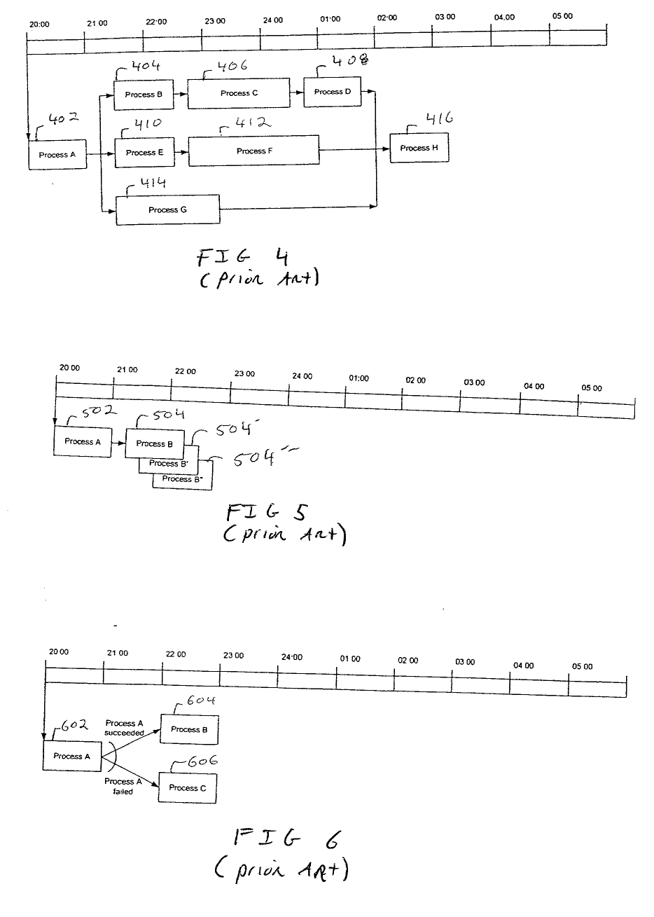

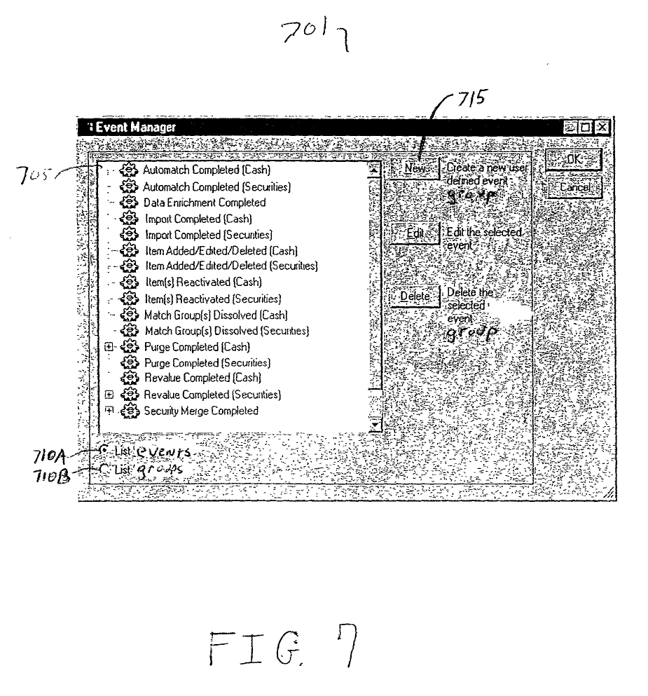

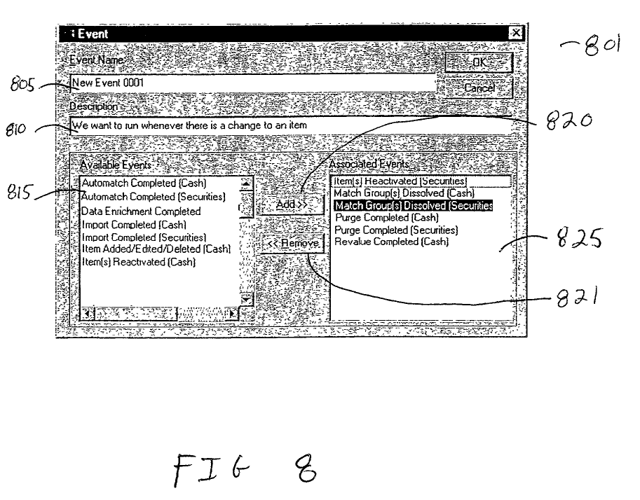

### DETAILED DESCRIPTION OF A PREFERRED EMBODIMENT

The inventive process management and scheduling technique is described and shown in the context of an accounting application system performing batch processing. However, it will be readily apparent that the present invention is equally applicable to any application system which performs batch and other processing.

In accordance with the present invention, a computer memory stores distinct data groups utilized in providing unified process management and scheduling. These data groups can be stored as database tables or as files. A first data group consists of events. Events are of two types: internal and external. Internal events are events performed by an application system which are not necessarily designed to result in any change to any database or other data collection. External events are events which result in a change to any database or other data collection utilized by the application system. External events can be caused by another application system, or by other systems and processes. Further, an external event can be an actual alteration of a database itself, not only actions designed to result in a change to a database. It will be understood that each application system utilizing the present technique would have a unique set of events, both internal and external.

Each event included in the events data group is associated with a unique event code and preferably a brief textual description of the event. The events data group is preferably end-user configurable as desired. That is, events, both internal and external, from which a user can pick and choose in defining triggering events for processes can be easily added and deleted. Configuration of events can be done through either a batch or online utility.

A second data group consists of event-groups. An event-group is merely an end-user defined group of events, though predefined event-groups are possible. An event-group allows scheduling to be based upon a combination of events. That is, if each of the multiple events which comprise an event-group have occurred, a schedule is eligible for execution. Each event-group is associated with a unique event-group code distinct from those for individual events. Each event-group is stored in association with its unique event-group code, the event codes for each individual event included in the event-group, and preferably a brief textual description of the event-group. Any given individual event can exist in more than one event-group. Furthermore, a first event-group can be included as a part of another event-group.

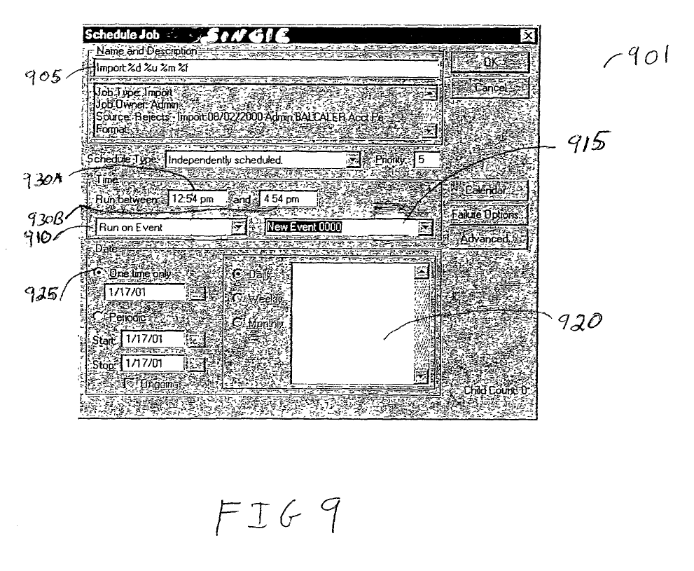

FIG. 7 is an exemplary screen shot of an Event Manager dialog box 701 presented to an end-user. The Event Manager dialog box 701 includes a window 705 listing events and event-groups. As the invention is being described in the context of an accounting application system, the events and event-groups shown relate to accounting. For example, the first listed event is labeled “Automatch Completed (Cash).” This event is the matching of corresponding cash transaction entries stored in a database utilized by the accounting application system. Discussed above, events include internal events, which are actions performed by an application system which are not designed to result in a change to a database, and external events, which are actions which result in a change to a database.

As shown in FIG. 7 an end-user can select to view events 710A, both internal and external, or view event-groups 710B. Furthermore, from the Event Manager dialog box 701 the end-user can access another dialog box to add an event-group 715. FIG. 8 is an exemplary screen shot of an Event dialog box 801. The end-user assigns a name 805 to the new event-group and provides a brief description 810. An Available Events window 815 is populated with defined events, both internal and external, and event-groups. The end-user selects one or more available entries and actives an Add control 820 to cause the entry (entries) to be placed in an Associated Events window 825. Likewise, the end-user can remove entries from the Associated Events window utilizing a Remove control 821.

A third data group consists of schedules. A schedule defines when a job should be executed. A job can consist of a single process or a group of processes. When a job consists of a group of processes, the schedule includes triggering criteria for each included process. Triggering criteria, for both a job having a single process and a job having a group of processes, can be time-based, can be event-based, or can be both time- and event-based. It should be noted that event-based triggering criteria can be occurrence of a single event, either internal or external, or upon occurrence of an event-group, that is, multiple system events. Also, a process can be associated with more than one job. Schedules can be defined either online, or in batch. Furthermore, a schedule can be associated with a concurrency limit. That is, an end-user can specify how many instances of the same job can execute at the same time.

FIG. 9 is an exemplary screen shot of a Schedule Job-Single Process dialog box 901 for the online scheduling a job having a single process. As shown, the Schedule Job-Single Process dialog box 901 includes a field 905 for the process to be identified. Utilizing this dialog box an end-user can schedule a job based upon time and/or occurrence of a single event or event-group. To run a job based upon time only, a selection of “Run on Time” indication would be chosen form a Job Run field 910, though “Run on event” is shown in FIG. 9. To run a job based upon an event-group or single event only, a selection of “Run on Event” indication (as shown) would be chosen from the Job Run field 910. To run a job based upon time and event, a selection of “Run on Event and Time” indication would be chosen from the Job Run field 910. The dialog box includes a field 915 to indicate an event or event-group as the triggering criteria. Further, the dialog box includes a window 920 in which to enter times as triggering criteria. The dialog box includes a selector 925 for selecting a one time only job. Also, the dialog box includes fields 930A and 930B to designate an eligibility window which defines a period of time (window) in which a job can be executed.

A fourth data group is an events log. This is a dynamic collection of events, both internal and external, that have occurred. Events are added to the events log as they occur. Preferably, an event is removed from the events log if no scheduled job relies upon that event as a trigger, or when a subsequent occurrence of a logged event happens. Further, events may be removed after some lapsed time.

A fifth data group is an initiated job log. This is a dynamic collection of initiated jobs. As a job is initiated, an indication is added to the initiated job log that the job has started. Upon completion of a job, the indication of that job is removed from the initiated job log. The initiated job log enables time-based jobs to be executed only once when scheduler control agent polling occurs frequently within an eligibility window, to be further discussed below, and enables concurrency limits to be enforced.

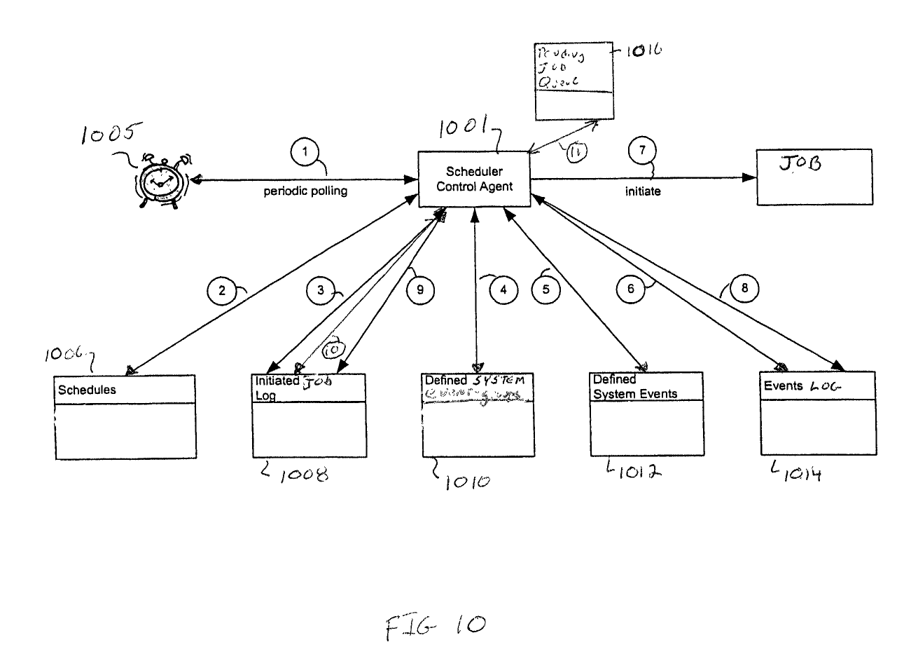

A scheduler control agent continually examines application system conditions and executes application system processes appropriately. FIG. 10 is a simplified diagram of the operations of the scheduler control agent 1001.

The scheduler control agent 1001 periodically determines which, if any, jobs should be executed. That is, the scheduler control agent 1001 operates in examination cycles. Preferably, the cycle is on the order of seconds or minutes and is end-user configurable. The scheduler control agent 1001 is in communication with a system clock 1005, as shown in 1. Time supplied by the system clock triggers the scheduler control agent 1001 execution cycle.

As shown at 2, upon beginning an execution cycle the scheduler control agent 1001 accesses the schedules data group 1006, discussed above, and identifies all time-based scheduled jobs, all time- and event-based scheduled jobs, and all event-based scheduled jobs (event-based jobs including jobs based upon occurrence of a single event or upon occurrence of an event-group). Based upon the time supplied by the system clock 1005, the scheduler control agent 1001 determines which of the time-based scheduled jobs are eligible for execution. For each time-based scheduled job that is eligible for execution, i.e., whose time is ripe, the scheduler control agent 1001 accesses the initiated job log 1008, discussed above, to determine if that job has already been initiated, as shown at 3. This is particularly helpful for those jobs which are scheduled to run once during an eligibility window, or scheduled to run n times during the window. The time-based ripe jobs that are not listed in the initiated job log 1008 are executed, as shown at 7. An indication that a particular job has been executed is stored in the initiated job log 1008, as shown at 9.

Alternatively, instead of accessing the initiated job log 1008 to determine if a job is currently executing, the scheduler control agent 1001 could access a job status listing, not shown in FIG. 10, which lists, among other information, an indication of the next time any particular job is scheduled for execution. Upon completion of a job, that job's status would be updated to reflect the next scheduled execution of that job.

For the time- and event-based scheduled jobs, the scheduler control agent 1001 determines, based upon the system clock, which of these are ripe.

For a time- and event-based job whose time is ripe, as well as for an event-based job, the scheduler control agent 1001 identifies all event codes and event-group codes associated with that job. This information is stored in the schedules data group. The scheduler control agent 1001 then accesses the event-groups data group 1010, at 4, and the events data group 1012, at 5, and determines the events associated with the codes. Next, the scheduler control agent 1001 accesses the events log 1014, at 6, to determine if the required events have transpired. That is, if an indication of such events or events is stored in the events log 1014 is determined.

If so, the scheduler control agent 1001 determines, from the information in the schedules data group, if the job is associated with any concurrency limits. If not, the job is executed 7 and an indication of such is stored in the initiated job log 1008, as shown at 9. If so, the scheduler control agent 1001 accesses the initiated job log 1008 and determines the number of instances of the job currently being executed, as shown in 10. If the number is less than the concurrency limit, the job is executed, 7, and an indication of such is stored in the initiated job log 1008, 9. If the number is equal to the concurrency limit, the job is placed in a pending job queue 1016, as shown in 11. This queue is then examined by the scheduler control agent 1001 each time a cycle is executed. A pending job in the pending job queue 1016 is initiated when the number of executing versions of that job drops below the limit, i.e., one of the concurrent jobs finishes and its entry is cleared from the initiated process log. It should be noted that the triggering events associated with pending jobs are not cleared from the events log, which allows the process to be initiated as soon as the number of concurrent jobs drops below the maximum threshold.

Following initiation of any event-based job, the scheduler control agent 1001 clears the associated events from events log 1014, as shown at 8, unless another job relies upon those events. Reliance by another job is determined by the scheduler control agent 1001 accessing the schedules data group 1006 and identifying each triggering event for each scheduled job.

The present invention is not to be limited in scope by the specific embodiments described herein. Indeed, various modifications of the present invention in addition to those described herein, will be apparent to those of skill in the art from the foregoing description and accompanying drawings. Thus, such modifications are intended to fall within the scope of the appended claims.

What is claimed is:

1. A method for performing a batch process, comprising:
storing information identifying a process other than a scheduled process;
detecting performance of the identified process; and
performing a batch process based on detection of the performance of the identified process.

2. The method of claim 1, wherein the identified process is performed on-line.

3. The method of claim 1, further comprising:
storing first detection information indicating the detection of the performance of the identified process;
storing timing information representing a time;
detecting a time corresponding to the stored timing information; and
storing second detection information indicating the detection of the corresponding time;
wherein the batch process is performed only if the first detection information and the second detection information are stored.

4. The method of claim 1, wherein the identified process is one of a plurality of processes, other than scheduled processes, and further comprising:
selecting the identified process from the plurality of processes prior to storing the information identifying the process.

5. The method of claim 4, wherein the identified process is a first process selected from a first plurality of processes other than scheduled processes, and further comprising:
selecting a second process from a second plurality of processes;
storing information identifying the second process;
detecting performance of the second process;
storing first detection information indicating the detection of the performance of the first process; and
storing second detection information indicating the detection of the performance of the second process;
wherein the batch process is performed only if the first detection information and the second detection information are stored.

6. The method of claim 5, wherein:
the first process is performed by a first computing application; and
the second process is performed by one of the first computing application and a second computing application.

7. The method of claim 1, wherein the identified process is an accounting process.

8. A method for executing a batch process, comprising:
storing information identifying a first event, the first event being performance of an unscheduled process;
storing information identifying at least one other event, each of the at least one other event being one of performance of a scheduled process, and clocking of a time;
detecting occurrence of the first event and the at least one other event; and
executing a batch process only upon detection of the occurrence of the first event and the at least one other event.

9. The method of claim 8, further comprising:
selecting the first event and the at least one other event from a plurality of events prior to storing identifying information.

10. The method of claim 8, wherein the unscheduled process is performed on-line.

11. The method of claim 8, wherein at least the first event is associated with an accounting computing application.

12. The method of claim 8, wherein performance of the unscheduled process alters a database.

13. A system for executing a batch process, comprising:
a memory configured to store instructions for performing a first process, instructions for performing a second process, the second process being a batch process, and information identifying the first process; and
a processor configured to execute the first process, detect performance of the first process based upon the stored information identifying the first process, and execute the second process based on detection of the performance of the first process.

14. The system of claim 13, wherein the first process is performed on-line.

15. The system of claim 13, wherein:
the memory is further configured to store first detection information indicating the detection of the performance of the first process, timing information representing a time, and second detection information indicating detection of the time; and
the processor is further configured to cause the first detection information to be stored in the memory, detect a time corresponding to the stored timing information, cause the second detection information to be stored in the memory, and execute the second process only if the first detection information and the second detection information are stored in the memory.

16. The system of claim 13, wherein:
the first process is one of a plurality of processes; and
the first process is selected from the plurality of processes by a user; and
the information identifying the first process is stored in the memory in response to the user selection of the first process.

17. The system of claim 16, wherein:
the memory is further configured to store instructions for performing a third process, information identifying the third process, first detection information indicating the detection of the performance of the first process, and second detection information indicating detection of performance of the third process;
the processor is further configured to cause the first detection information to be stored in the memory, execute the third process, detect performance of the third process based upon the stored information identifying the third process, cause the second detection information to be stored in the memory, and execute the second process only if the first detection information and the second information are stored in the memory.

18. The system of claim 17, wherein:
the first process is a process performed by a first computing application; and
the third process is a process performed by one of the first computing application and a second computing application.

19. The system of claim 13, wherein the first process is a process performed by an accounting application.

20. A system for executing a batch process, comprising:
a memory configured to store information identifying a first event, the first event being performance of an unscheduled process, information identifying at least one other event, each at least one other event being one of performance of a scheduled process and a clocking of a time; and
a processor configured to detect occurrence of the first event and the at least one other event and execute a batch process only upon detection of the occurrence of the first event and the at least one other event.

21. The system of claim 20, wherein:
the one event and the at least one other events are selected from a plurality of events by a user prior to storage of the identifying information.

22. The system of claim 20, wherein the unscheduled process is performed on-line.

23. The system of claim 20, wherein at least the first event is associated with an accounting computing application.

24. The system of claim 20, wherein performance of the unscheduled process alters a database.
